(19) United States
(12) Patent Application Publication
(10) Pub. No.: US 2026/0066991 A1
(43) Pub. Date: Mar. 5, 2026

(54) OPTICAL WIRELESS COMMUNICATION APPARATUS

(71) Applicant: Tamron Co., Ltd., Saitama (JP)

(72) Inventors: Yusuke HASHIMOTO, Saitama (JP); Shingo FUSE, Saitama (JP); Takashi SAKAMOTO, Saitama (JP)

(73) Assignee: Tamron Co., Ltd., Saitama (JP)

(21) Appl. No.: 19/273,805

(22) Filed: Jul. 18, 2025

(30) Foreign Application Priority Data
Sep. 5, 2024 (JP) 2024-153415

(51) Int. Cl. H04B 10/112; G02B 6/35; H04B 10/61

(52) U.S. Cl. CPC H04B 10/1127; G02B 6/3512; H04B 10/614

(57) ABSTRACT

A transmission optical system and a reception optical system of an optical wireless communication apparatus are independent of each other. Optical paths of a signal light from an antenna for both transmission and reception are parallel to each other. An integrated fast steering mirror (FSM) is arranged to span both of the optical paths.

### CROSS-REFERENCE TO RELATED APPLICATIONS

This application is based on and claims the benefit of priority from Japanese Patent Application No. 2024-153415, filed on Sep. 5, 2024, the entire contents of which are incorporated herein by reference.

### BACKGROUND OF THE INVENTION

### Technical Field

The present invention relates to an optical wireless communication apparatus.

### Related Art

Light, like radio waves currently used in communication, is an electromagnetic wave. However, in wireless communication, light can be freely used without restrictions under the Radio Law. Further, since light has high directivity, light does not propagate over a wide area and thus is advantageous in terms of security in wireless communication compared to radio waves that propagate over a wide area. Optical wireless communication is considered suitable for communication between fixed base stations and is also considered advantageous as a complementary technology to radio waves for communication between artificial satellites in outer space. Consequently, in recent years, research on optical wireless communication technology has advanced, and precise optical technologies for achieving higher speeds and longer distances in optical wireless communication are expected.

In such an optical wireless communication apparatus, there is known an apparatus that performs both transmission and reception of a signal light with one antenna, wherein a transmission optical system and a reception optical system share the same optical axis and share one steering mirror. Among these, there is known an optical wireless communication apparatus wherein a portion of the transmission optical system and the reception optical system is coaxially configured, a steering mirror is arranged in the coaxial portion of the optical systems to synchronously control the exit angles of both the transmission signal light and the reception signal light, and a polarization beam splitter or dichroic mirror for separating signal light is arranged in the coaxial portion of the optical systems to separate the transmission signal light and the reception signal light from the signal light in the portion (see, for example, “Miniaturized Multi-Platform Free-Space Laser-Communication Terminals for Beyond-5G Networks and Space Applications” (Alberto Carrasco-Casado and 5 others, DOI: 10.3390/photonics11060545)).

Further, among optical wireless communication apparatuses, there is commercially available a spatial optical transmission apparatus which is configured of a pair of transmission and reception devices and in which a transmission optical system or a reception optical system on one side can be arranged to face a reception optical system or a transmission optical system on another side.

In the optical wireless communication apparatus described in “Miniaturized Multi-Platform Free-Space Laser-Communication Terminals for Beyond-5G Networks and Space Applications”, transmitted signal light and received signal light traveling along the same optical axis are controlled by a common steering mirror. Therefore, it is possible to precisely and synchronously control the communication directions of both the transmission signal light and the reception signal light.

However, the optical wireless communication apparatus described in “Miniaturized Multi-Platform Free-Space Laser-Communication Terminals for Beyond-5G Networks and Space Applications” uses a dichroic mirror arranged on the optical axis to separate the signal light. Consequently, back-reflected light may occur at this mirror, potentially causing communication errors. Additionally, since the signal light is separated based on wavelength, it is necessary for the transmission signal light and the reception signal light to have different wavelengths, and therefore, signal light of the same wavelength cannot be used.

In addition, in the optical wireless communication apparatus described in “Miniaturized Multi-Platform Free-Space Laser-Communication Terminals for Beyond-5G Networks and Space Applications”, the dichroic mirror arranged on the optical axis is used to separate a desired one of the transmission signal light and the reception signal light based on a difference in wavelength. This introduces wavelength selectivity between the transmission signal light and the reception signal light. When a polarization beam splitter (PBS) is used to separate the signal light, the separation of the transmission signal light and the reception signal light is performed based on polarization, resulting in signal light with mismatched polarization being discarded by the PBS, and additionally hindering the increase in transmission speed due to polarization.

In contrast, “Development Status of LCT for Inter-Satellite Communication” (Kosuke Kiyohara and 4 others, The Japan Society for Aeronautical and Space Sciences, Proceedings of the 67th Space Sciences and Technology Conference, October 2023) proposes pupil-division-based transmission-reception separation, which is an excellent approach independent of wavelength and polarization. However, this approach also faces the issue of loss because the pupil-division mirror blocks reception light.

On the other hand, commercially available spatial optical transmission apparatuses have independent optical systems for transmission and reception, enabling bidirectional data transmission using light. However, the transmission distances of those apparatuses are limited to several hundred meters, making those apparatuses unsuitable for long-distance communication. Additionally, those apparatuses lack configurations for precisely controlling the communication direction of signal light.

As described above, conventional optical wireless communication apparatuses allow precise and synchronous control of the communication directions of transmitted and received signal light. However, their configurations result in the loss of nearly half of the signal light energy. In conventional optical wireless communication apparatuses, at least in this respect, there remains room for further consideration.

One aspect of the present invention aims to implement an optical wireless communication apparatus capable of reducing energy loss in signal light while maintaining precise and synchronous control over the communication directions of transmitted and received signal light.

### SUMMARY OF THE INVENTION

To solve the above problems, an optical wireless communication apparatus according to one aspect of the present invention includes: a first optical system that includes a light source of a signal light and a first antenna for transmitting the signal light, the first optical system being configured to transmit the signal light from the light source to the first antenna; and a second optical system that includes a receiver for the signal light and a second antenna for receiving the signal light, the second optical system being configured to transmit the signal light from the second antenna to the receiver, wherein the first optical system and the second optical system include a parallel portion in which an optical path of the signal light from the first antenna in the first optical system and an optical path of the signal light from the second antenna in the second optical system are parallel to each other, and share an optical drive element which is arranged on each of the optical paths in the parallel portion and is configured to deflect the signal light to remove disturbances in a plurality of incident signal light beams.

### Effect of the Invention

According to one aspect of the present invention, it is possible to implement an optical wireless communication apparatus capable of reducing energy loss in signal light while maintaining precise and synchronous control over the communication directions of transmitted and received signal light.

### BRIEF DESCRIPTION OF THE DRAWINGS

FIG. 1 is a schematic diagram of a configuration of an optical wireless communication apparatus according to Embodiment 1 of the present invention;

FIG. 2 is a schematic diagram of a configuration of an antenna according to Embodiment 1 of the present invention;

FIG. 3 is a schematic diagram of a configuration of an optical wireless communication apparatus according to Embodiment 2 of the present invention; and

FIG. 4 is a diagram illustrating features of other embodiments of the present invention.

### DESCRIPTION OF THE EMBODIMENTS

### Embodiment 1

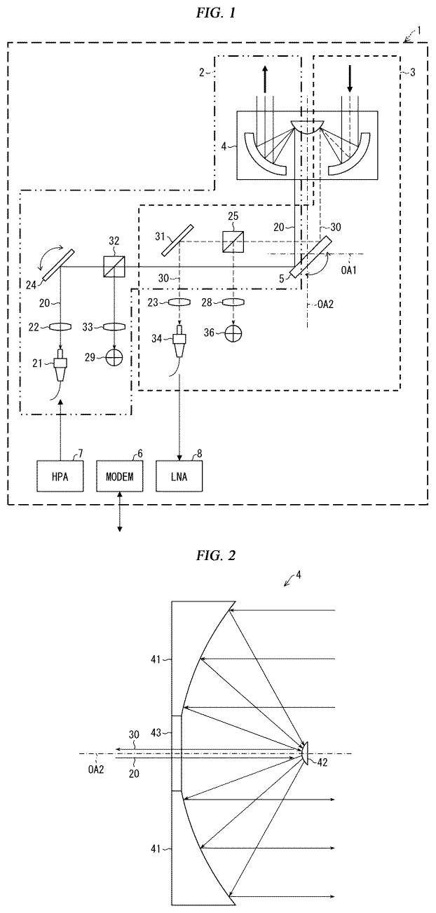

FIG. 1 schematically illustrates a configuration of an optical wireless communication apparatus 1 according to Embodiment 1 of the present invention. The optical wireless communication apparatus 1 is for satellite use, enabling laser communication between satellites or between satellites and ground stations.

The optical wireless communication apparatus 1 includes: a first optical system 2 for transmission; a second optical system 3 for reception; an antenna 4 for transmission and reception; a fast steering mirror 5 for fine tracking of communication partners; a modem 6; a high power amplifier 7; and a low noise amplifier 8.

The modem 6 is a modulator-demodulator that converts analog signals to digital signals and digital signals to analog signals, enabling data transmission and data reception via communication lines for apparatuses such as computers.

The high power amplifier 7 amplifies low power optical signals output from the modem 6 without converting them to electrical signals, maintaining the signals in their optical form. In optical wireless communication, high-power optical fiber amplifiers (e.g., erbium-doped fiber amplifiers (EDFAs)) are primarily used.

The low noise amplifier 8 is a device that amplifies signals input from, for example, the antenna. The low noise amplifier 8 is used to improve noise characteristics of the reception device.

### [First Optical System]

The first optical system 2 includes: a cable connector 21 that outputs transmitted signal light (hereinafter referred to as “transmission signal light”); a collimator 22; an aberration correction mirror 24; a beam splitter 32; a fast steering mirror 5; and the antenna 4.

The cable connector 21, which outputs the transmission signal light transmitted via an optical fiber cable in the first optical system 2, corresponds to the light source of the signal light.

The collimator 22 is configured to output the transmission signal light as collimated light.

The aberration correction mirror 24 is a reflective mirror driven by an actuator which is not illustrated. The aberration correction mirror 24 is driven, for example, in the direction indicated by the arrow in FIG. 1 to cancel out the relative movement with a communication partner. Thus, the first optical system 2 further includes a drive mirror, which can adjust the orientation of the mirror surface for incident transmission signal light, between the cable connector 21 and the beam splitter 32 to be described later.

The beam splitter 32 functions as a half mirror for the transmission signal light, branching a portion of the transmission signal light at a 90-degree angle while allowing the remainder to pass through.

The transmission signal light transmitted through the beam splitter 32 is reflected by the fast steering mirror 5, transmitted to the antenna 4, and output from the antenna 4 toward a communication partner satellite. The fast steering mirror 5 and the antenna 4 will be described later.

The first optical system 2 includes: a focusing lens 33 that focuses the transmission signal light branched by the beam splitter 32 toward subsequent stage; and a first quadrant photodetector 29 that detects the reception position of the transmission signal light focused by the focusing lens 33. The first quadrant photodetector 29 is a detector capable of converting the detected light signal into an electrical signal, and is, for example, a CCD sensor. Thus, the first optical system 2 further includes a position detection mechanism that detects the position of the transmission signal light in the transverse plane of the optical path 20 of the transmission signal light.

In the first optical system 2, the optical path of the transmission signal light is indicated by an arrow labeled with reference numeral 20. The optical path 20 of the transmission signal light corresponds to the optical axis of the transmission signal light in the first optical system 2, representing the central position of the transmission signal light beam in the radial direction. For example: the optical path 20 from the cable connector 21 to the aberration correction mirror 24 is a straight line connecting the centers of these optical elements; the optical path 20 from the beam splitter 32 to the first quadrant photodetector 29 is a straight line connecting the centers of the focusing lens 33 and the first quadrant photodetector 29. The optical path 20 from the aberration correction mirror 24 to the antenna 4 will be described later.

### [Second Optical System]

The second optical system 3 includes: the antenna 4; the fast steering mirror 5; a beam splitter 25; a folding mirror 31; a focusing lens 23; and a cable connector 34.

The beam splitter 25 functions as a half mirror for the reception signal light, allowing a portion of the reception signal light to pass through while reflecting the remainder at a 90-degree angle.

The focusing lens 23 focuses the reception signal light reflected by the folding mirror 31 toward the cable connector 34, which receives the focused reception signal light. The cable connector 34 corresponds to a receiver for the signal light, since the cable connector 34 receives the signal light transmitted through the second optical system 3.

Additionally, the second optical system 3 includes a focusing lens 28 and a second quadrant photodetector 36. The second quadrant photodetector 36 detects the reception position of the reception signal light branched by the beam splitter 25 and focused by the focusing lens 28. The second quadrant photodetector 36 is a detector capable of converting optical detection signals into electrical signals, such as a CCD sensor. Thus, the second optical system 3 further includes a position detection mechanism that detects the position of the reception signal light in the transverse plane of the optical path of the reception signal light.

In the second optical system 3, the optical path of the reception signal light is indicated by an arrow labeled with reference numeral 30. An optical path 30 of the reception signal light corresponds to the optical axis of the reception signal light in the second optical system 3, representing the central position of the reception signal light beam in the radial direction. For example: the optical path 30 from the beam splitter 25 to the second quadrant photodetector 36 is a straight line connecting the centers of the intervening optical elements; the optical path 30 from the beam splitter 25 to the cable connector 34 is a straight line connecting the centers of the intervening optical elements. The optical path 30 from the antenna 4 to the beam splitter 25 will be described later.

### [Configuration of Common Portions]

The first optical system 2 and the second optical system 3 share the fast steering mirror 5 and the antenna 4. These configurations are positioned on the optical paths of both the transmission signal light and the reception signal light.

The fast steering mirror 5 is supported to be drivable by two or more actuators which are driven by, for example, voice coil motors, and is configured to freely adjust the orientation of the mirror surface. Thus, the fast steering mirror 5 is a two-dimensional drive mirror capable of changing the orientation of the mirror surface on which signal light is incident, and is configured to control the exit angle of the incident signal light to a specific exit angle precisely and rapidly. In communication fields, the fast steering mirror 5 is also referred to as “Fine Pointing Mirror”.

As illustrated in FIG. 2, the antenna 4 is an off-axis binocular-type antenna. The antenna 4 includes a principal mirror 41 and a sub mirror 42. The principal mirror 41 has a concave surface, with a window 43 opening at the center of the concave surface, and is arranged in a manner that the concave surface is concave outward along a central axis OA2. The sub mirror 42 has a convex surface and is positioned at the center of the principal mirror 41 opposite to the window 43 (on the central axis OA2) with the convex surface facing the principal mirror 41.

The principal mirror 41 is designed to reflect collimated light received from the direction along the central axis OA2 toward the sub mirror 42 and to reflect the signal light received from the sub mirror 42 as collimated light in the direction along the central axis OA2.

The transmission signal light that has been transmitted through the optical path 20 and passed through the window 43 is reflected by a portion on one side (for example, the lower side in FIG. 2) of the sub mirror 42, reaches a portion on one side (for example, the lower side in FIG. 2) of the principal mirror 41 relative to the window 43 while expanding the beam diameter, and is emitted to the outside as the signal light of collimated light.

The signal light of collimated light that has reached a portion on another side (for example, the upper side in FIG. 2) of the principal mirror 41 relative to the window 43 from the outside is reflected by the principal mirror 41 and is focused onto a portion on another side (for example, the upper side in FIG. 2) of the sub mirror 42. The sub mirror 42 reflects the signal light, which has been reflected from the portion on the another side of the principal mirror 41, as collimated light that propagates in the direction along the central axis OA2 with the optical path 30 as the center of the beam diameter.

Thus, the first optical system 2 and the second optical system 3 share the antenna 4, which is capable of transmitting and receiving a plurality of signal light beams in an integrated manner. The first optical system 2 and the second optical system 3 have the optical path 20 for the transmission signal light and the optical path 30 for the reception signal light, which are in a mutually parallel positional relationship, between the antenna 4 and the fast steering mirror 5.

For example, the central axis OA2 is defined as a straight line connecting the center of the fast steering mirror 5 and a center of a window 44 of the antenna 4. The central axis OA1 is defined as a straight line passing through the center of the transmission-reception optical path from the transmission-reception side and through the center of the fast steering mirror 5. The optical path 20 extends in the same direction as each of the central axis OA1 and the central axis OA2 and is separated from them by a specific distance. The optical path 30 extends in the same direction as each of the central axis OA1, the central axis OA2, and the optical path 20 and is separated from these optical axes and the optical path 20 by a specific distance.

The distance between the optical path 20 and each of the central axes OA1, OA2 is greater than the beam radius of the transmission signal light. The distance between the optical path 30 and each of the central axes OA1, OA2 is greater than the beam radius of the reception signal light. From the perspective of enhancing the precision of fine tracking of communication partners by the fast steering mirror 5 and minimizing the optical path difference between the transmission signal light and the reception signal light, these distances are all preferably small. Therefore, it can be said that the distances respectively between the central axes OA1, OA2 and the optical paths 20, 30 are preferably as small as possible within a range in which the beam of the transmission signal light and the beam of the reception signal light do not overlap.

Thus, the first optical system 2 and the second optical system 3 each include a portion in which the optical path 20 of the signal light from the antenna 4 in the first optical system 2 and the optical path 30 of the signal light from the antenna 4 in the second optical system 3 are parallel to each other. The first optical system 2 and the second optical system 3 share the fast steering mirror 5 on both the optical path 20 and the optical path 30 in the portions where these optical paths are parallel to each other.

### [Optical Wireless Communication]

The signal light sufficiently amplified by the high power amplifier 7 is transmitted from the cable connector 21 through the first optical system 2 to the antenna 4, and is output from the antenna 4 to the outside as expanded collimated light. The reception signal light received by the antenna 4 is transmitted through the second optical system 3 to the cable connector 34 and further transmitted to the low noise amplifier 8 through the cable connector 34. The reception signal light is sufficiently amplified by the low noise amplifier 8, and the generation of noise is suppressed. In the present embodiment, band signals are collectively converted into digital signals, and the digital signals are converted into optical signals and transmitted. Therefore, transmission with a high dynamic range that does not depend on the nonlinearity of the optical element is implemented.

When the relative positional relationship with the communication partner changes during optical wireless communication, in the first optical system 2, the aberration correction mirror 24 is driven in accordance with the positional relationship to continuously track the communication partner during transmission. A portion of the transmission signal light is branched by the beam splitter 32 and focused by the focusing lens 33, and then reaches the first quadrant photodetector 29. As the aberration correction mirror 24 is driven, the detection position of the transmission signal light by the first quadrant photodetector 29 is a position that has changed in accordance with the driving of the aberration correction mirror 24. The driving of the aberration correction mirror 24 is controlled by feedback control based on the detection position information obtained by the first quadrant photodetector 29, thereby allowing the signal light to be continously transmitted to the communication partner.

On the other hand, in the reception of signal light, a portion of the reception signal light is received by the second quadrant photodetector 36, and a change in the position of the reception signal light is detected. As a result, a change in the relative position between the optical wireless communication apparatus 1 and its communication partner is detected, and also a change (such as fluctuation) in the position of the reception signal light due to external disturbances such as weather-related disturbances or space propagation disturbances is detected. The position information of the reception signal light obtained by the second quadrant photodetector 36 is used for feedback control for driving the aberration correction mirror 24 for aberration correction, or for driving the fast steering mirror 5 for correction against external disturbances. It should be noted that the tracking of the relative positional relationship with the communication partner is also performed by controlling the attitude of the satellite on which the optical wireless communication apparatus 1 is mounted.

As described earlier, the fast steering mirror 5 is configured to precisely and rapidly control the exit angle of incident signal light to a specific exit angle. In the present embodiment, the fast steering mirror 5 is shared by both the first optical system 2 and the second optical system 3, and thus, the influence of external disturbances (for example, vibrations) on both the transmission signal light and the reception signal light can be canceled out simultaneously. As described above, in the present embodiment, vibration isolation for the transmission signal light and the reception signal light, which are not coaxial with each other, is implemented by one fast steering mirror 5.

### [Key Effects]

Although communication technologies using radio waves, such as 5G, have achieved dramatic increases in communication speed, their communication speed has theoretically reached an upper limit, and various difficulties are anticipated in achieving further speed improvement. From this perspective as well, optical wireless communication technology is attracting attention.

Optical wireless communication technology is still in its infancy, and in long-distance communication, coaxial transmission-reception optical systems are predominantly used. This is because it is necessary to eliminate the influence of disturbances in transmission and reception using one fast steering mirror. Therefore, in conventional optical wireless communication apparatuses, problems arise such as an increase in the number of components and greater loss in the internal optical system, or limitations on the wavelength or communication method used, or a loss of approximately half of the signal light energy due to the separation of transmission light and reception light caused by polarization. These problems can be a factor that hinders the high-speed communication in optical wireless communication technology.

In addition, in optical wireless communication apparatuses of the conventional technology, optical loss occurs due to the separation of transmission and reception. That is, in optical wireless communication apparatuses of the conventional technology, the optical system for transmission signal light and the optical system for reception signal light are arranged coaxially, and a fast steering mirror is arranged on the same axis to perform vibration compensation using the fast steering mirror. However, in such a case, it s necessary to use polarization beam splitter (PBS) to separate the optical paths of the transmission signal light and the reception signal light, resulting in a reduction of the quantity of light of the signal light by half, thereby causing such an energy loss. In addition, although pupil division methods also exist in the conventional technology, this conventional technology has the same problems as those using polarization beam splitters.

Moreover, since the conventional technology separates transmission and reception based on wavelength or polarization, the conventional technology hinders the advancement of high-speed communication using wavelength-division multiplexing or polarization, which is expected in next-generation communication. Furthermore, there is also a problem in which communication errors occur due to return light caused by surface reflection during the separation of signal light, and such a problem also becomes a hindrance to high-speed communication.

In the optical wireless communication apparatus 1, the first optical system 2 for transmission and the second optical system 3 for reception include portions in which the optical path 20 of the signal light from the antenna 4 in the first optical system 2 and the optical path 30 of the signal light from the antenna 4 in the second optical system 3 are parallel to each other, and the fast steering mirror 5 capable of deflecting these incident signal light beams is shared on both of the optical paths 20 and 30 in the parallel portions. Thus, in the present embodiment, the optical axes of transmission and reception are independent, and the fast steering mirror 5 is shared, and by deflecting the signal light, a structure that eliminates disturbance in the signal light is provided. Therefore, separation of the signal light after transmission and reception based on wavelength or polarization is not required. Accordingly, the present embodiment is also compatible with high-speed communication using wavelength-division multiplexing or polarization, which is expected to be implemented in the future. Moreover, since transmission and reception of the signal light can be performed without being affected by the wavelength of the signal light, the present embodiment is compatible with signal light of wavelengths usable in conventional optical wireless communication.

As described above, in the present embodiment, by adopting a structure in which the optical axes for transmission and reception are separated and a fast steering mirror is used in common, separation of transmission and reception that is independent of wavelength or polarization is implemented. As a result, methods for high-speed communication using wavelength-division multiplexing or polarization, which is likely to be implemented in the future, are not hindered. Furthermore, since light reception can be performed without being affected by the wavelength used in existing optical wireless communication apparatuses, data reception from other companies' optical wireless communication apparatuses also becomes possible. As a result, simplification of the internal optical system becomes possible and loss of light can be reduced.

The optical system on the antenna side relative to the fast steering mirror 5 constitutes an antenna optical system. The antenna optical system corresponds to the optical system from the fast steering mirror 5 to the antenna 4 in the common portion of the first optical system 2 and the second optical system 3 described above. The sharing of the antenna optical system by the optical system for transmission signal light and the optical system for reception signal light is preferable from the viewpoint of facilitating the construction of the optical system of the optical wireless communication apparatus. The antenna optical system may adopt either: an off-axis configuration where the principal mirror and the sub mirror are arranged such that the optical axis of the signal light of the sub mirror, which is located on the inner side of the optical wireless communication apparatus, is deviated relative to the optical axis of the signal light of the principal mirror, which is located on the outer side of the optical wireless communication apparatus; or a transmission type configuration constructed with lenses that change the beam diameter (enlarge the beam diameter during transmission). In the present embodiment, the antenna optical system functions as a kind of beam expander.

The optical system from the cable connector 21 to the fast steering mirror 5 constitutes the transmission optical system, which collimates laser light from an optical fiber cable such as a single-mode fiber and transmits it to the antenna optical system. The transmission optical system corresponds to the optical system on the light source side of the signal light relative to the fast steering mirror 5 in the first optical system 2 described above. Since the transmission signal light from the transmission optical system to the antenna optical system is composed of collimated light, it is possible to define the collimation diameter of the transmission signal light beam. Therefore, the configuration is advantageous from the viewpoint of designing the size of the fast steering mirror 5, and also advantageous from the viewpoint of arranging the aberration correction mirror 24 (beam steering mirror for transmission (e.g., pointing and acquisition mirror (PAM))) or the first quadrant photodetector 29 (position sensor).

The transmission optical system may be an off-axis configuration that changes the orientation of the optical axis using a mirror, or may be a transmission type configuration that changes the beam diameter using a lens.

The optical system from the cable connector 34 to the fast steering mirror 5 constitutes the reception optical system, which reduces and condenses the collimated light of the reception signal light from the counterpart optical wireless communication apparatus to an optical fiber cable such as a single-mode fiber. The reception optical system corresponds to the optical system on the detection side of the signal light relative to the fast steering mirror 5 in the second optical system 3 described above. The fact that the reception signal light of the reception optical system is configured as collimated light is advantageous, similarly to the transmission optical system described above, from the viewpoint of designing the size of the fast steering mirror 5, and also advantageous from the viewpoint of arranging components such as the second quadrant photodetector 36 (position sensor), because the collimation diameter of the reception signal light beam can be defined. Note that the reception optical system may be an off-axis configuration using a mirror or a transmission type configuration using a lens.

Moreover, in the present embodiment, since the optical path of the transmission signal light and the optical path of the reception signal light are not arranged coaxially but with a certain distance therebetween, a configuration that branches the signal light using a polarization beam splitter is not included, and thus, it is possible to construct a system that minimizes the power loss of the transmission signal light and the reception signal light. In the coaxial configuration of the conventional technology, the optical axis of the signal light is generally configured to be positioned at the center of the fast steering mirror, but since the present embodiment is not a coaxial configuration, the optical axes of the transmission signal light and the reception signal light are configured to be positioned on the outer periphery (for example, peripheral portion) of the fast steering mirror, rather than at the center of the fast steering mirror where the coaxial signal light reaches in the conventional technology. As a result, it is possible to simultaneously correct the vibrations of both the transmission signal light and the reception signal light using one fast steering mirror, just as in the conventional coaxial configuration.

Note that in the optical wireless communication apparatus 1, since the optical paths of the transmission signal light and the reception signal light are independent from each other, there is no need to distinguish between the transmission signal light and the reception signal light as described above. Therefore, both the transmission signal light and the reception signal light can be signal light of the same wavelength. Also, there is no need to separate one of the transmission signal light and the reception signal light from the other. Hence, there is no energy loss of the signal light associated with the separation of signal light, and also no return light which may occur during the separation of signal light, and may become noise in optical wireless communication. Furthermore, since no optical element is required for separating the signal light, the configuration of the optical system in the optical wireless communication apparatus 1 becomes simpler compared to that of the conventional optical wireless communication apparatus that requires signal light separation, and the loss of signal light can be further reduced.

Further, originally, although the signal light is collimated light in geometrical optics, its beam angle varies depending on the emission beam diameter in wave optics. When the emission beam diameter of the signal light is large, collimation is high and signal light rays closer to parallel light are emitted. Conversely, as the emission beam diameter of the signal light becomes smaller, the collimation of the signal light becomes lower, and the beam angles of the signal light rays increase (become more divergent).

When the optical wireless communication apparatus 1 is applied to optical wireless communication in outer space, the distance between the optical wireless communication apparatuses that communicate with each other may become extremely long, for example, from 1000 km to 4000 km. Therefore, when the beam angles of the signal light rays increase, the beam diameter of the signal light reaching the counterpart optical wireless communication apparatus becomes large. The energy of the reception signal light is determined by the beam diameter of the reception signal light which is received and the aperture of the reception optical system. Accordingly, the optical wireless communication apparatus is preferable from the viewpoint that the efficiency of optical wireless communication is further improved as either the beam diameter of the transmission signal light or the beam diameter of the reception signal light increases, but in practice, the optical wireless communication apparatus is subject to size constraints, and thus the beam diameter of the signal light is also limited.

In the optical wireless communication apparatus of the conventional technology, the optical path of the transmission signal light and the optical path of the reception signal light are coaxial, and thus, both are operated with the same aperture (with the same beam diameter). In contrast, in the present embodiment, the optical path of the transmission signal light and the optical path of the reception signal light are not coaxial, and are separate optical paths. Therefore, since energy loss of signal light due to a polarization beam splitter in the conventional technology does not occur, it is possible to reduce the aperture of the optical system for the transmission signal light compared to that of the conventional technology. Independently reducing the beam diameter of the transmission signal light makes it possible to increase the energy amount of the transmission signal light arriving at the counterpart optical wireless communication apparatus beyond the energy amount of the signal light (reception signal light) that has arrived, considering the energy loss amount due to the polarization beam splitter in the conventional technology, thereby achieving higher efficiency and size reduction compared to the optical wireless communication apparatuses of the conventional technology.

Furthermore, the optical wireless communication apparatus 1 includes the fast steering mirror 5, which is a two-dimensional drive mirror capable of changing the orientation of the mirror surface on which the signal light of each optical system is incident. Therefore, it is advantageous from the viewpoint of more promptly and precisely canceling the influence on the communication light caused by external disturbances.

Moreover, the optical wireless communication apparatus 1 shares the antenna 4 which can transmit and receive the signal light in an integrated manner, and serves as both the transmission antenna and the reception antenna. Thus, it is advantageous from the viewpoint of simplifying the antenna configuration of the optical wireless communication apparatus 1.

In the optical wireless communication apparatus of the conventional technology, the antenna optical system is mostly of the Cassegrain type. In the Cassegrain-type system, both the optical system for the transmission signal light and the optical system for the reception signal light can share the antenna optical system. However, in the Cassegrain-type system, the principal mirror and the sub mirror face each other, and thus, the aperture in the principal mirror corresponding to the sub mirror becomes larger. As a result, a greater loss of the quantity of light of the signal light is more likely to occur.

In the present embodiment, the off-axis binocular-type antenna 4 is adopted as the integral antenna. Accordingly, one of the two divided parts of the principal mirror 41 of the antenna 4 can be used for transmission, and the other for reception. Therefore, it is advantageous from the viewpoint of reducing the signal light loss in transmission and reception through the antenna.

It should be noted that, in the present invention, not only the binocular configuration for transmission light and reception light as in the present embodiment but also a multi-aperture configuration with more than two apertures may be adopted. In such a case, additional optical paths for transmission signal light or additional optical paths for reception signal light may be provided, and the number of optical paths for the signal light may be any number as long as dimensional constraints allow.

In the present embodiment, the optical path of the transmission signal light and the optical path of the reception signal light are not set coaxially, and thus, there is no need to provide a hole at the center of the optical path (on the optical axis) as in the Cassegrain-type system. Thus, it is preferable from the viewpoint of constructing an optical wireless communication apparatus in which the loss of the quantity of light of the signal light during transmission and reception through the antenna is reduced.

In addition, when the collimation diameters of the signal light beams respectively in the optical system for transmission signal light and the optical system for reception signal light are made the same, the collimation diameters of the signal light beams respectively for transmission and reception in the antenna optical system can also be made the same. Thus, the transmission aperture and the reception aperture in the principal mirror of the antenna can be made substantially the same. Accordingly, the internal energy ratio between the transmission signal light and the reception signal light can be made equal, which is preferable from the viewpoint of improving efficiency.

Furthermore, in cases where the size of the optical wireless communication apparatus is restricted or where the energy of the transmission signal light can be made sufficiently high, it is possible to reduce the size of the optical wireless communication apparatus itself by appropriately setting the beam diameter in the transmission optical system and the beam diameter in the reception optical system. Adopting a multi-aperture type in the present embodiment is also preferable from the viewpoint of achieving the size reduction described above.

Further, the optical wireless communication apparatus 1 includes, in the first optical system 2, a configuration for detecting the position of the signal light in the transverse plane of the optical path of the signal light to be transmitted (specifically, the beam splitter 25 and the first quadrant photodetector 29), and in the second optical system 3, a configuration for detecting the position of the signal light in the transverse plane of the optical path of the received signal light (specifically, the beam splitter 32 and the second quadrant photodetector 36). Accordingly, the optical wireless communication apparatus 1 is advantageous from the viewpoint of tracking the communication partner based on the position detection of the signal light and suppressing the influence of disturbances.

A position detection sensor is arranged in the optical path of the transmission optical system in this way and is configured to be capable of feeding back to the aberration correction mirror 24, and thus, it is possible to more accurately emit the signal light toward the counterpart optical wireless communication apparatus. As a result, communication efficiency can be enhanced. Such an optical system configuration includes a beam splitter, but in the present embodiment, the transmission-side power itself can be made relatively large, for example in the range of 1 w to 10 w. In this case, in order to avoid detection failure due to an excessive quantity of light, it is necessary to significantly reduce the arrival energy on the position detection sensor side. Therefore, the proportion of the transmission signal light directed to the transmission side (toward the fast steering mirror 5) via the beam splitter in the transmission optical system inevitably becomes larger, making it possible to sufficiently minimize the energy loss associated with position detection in the transmission signal light.

Moreover, by arranging the position detection sensor in the optical path of the reception optical system and configuring the detection result to be feedable back to the fast steering mirror 5 as described above, it is possible to compensate for micro-vibrations not fully controllable by the gimbal (e.g., attitude control of the host body mounted with the optical wireless communication apparatus 1 via a gyro sensor) via the fast steering mirror 5, thereby allowing the transmission signal light transmitted from the counterpart optical wireless communication apparatus to be more accurately incident, thus further improving the reception efficiency. The reception optical system generally receives transmission light from a distant source as the reception signal light, and thus, the arrival energy of the reception signal light becomes significantly smaller than the energy possessed by the transmission signal light. However, by adopting a highly sensitive position detection sensor, it is possible to sufficiently detect the reception signal light with the position detection sensor.

Further, the optical wireless communication apparatus 1 includes an aberration correction mirror 24 between the cable connector 21 and the beam splitter 32 in the first optical system 2. Thus, it is advantageous from the viewpoint of substantially canceling the influence on communication caused by the relative movement of the communication partner.

### Embodiment 2

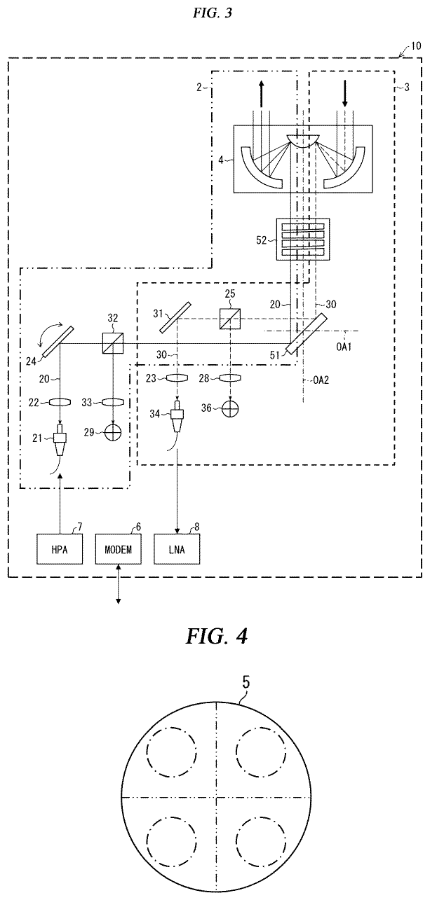

A configuration of an optical wireless communication apparatus according to the present embodiment is schematically illustrated in FIG. 3. An optical wireless communication apparatus 10 has substantially the same configuration as the above-described optical wireless communication apparatus 1 of Embodiment 1, except that, instead of the fast steering mirror 5, the optical wireless communication apparatus 10 includes an optical drive element 52 composed of two pairs of wedge prisms. Reference numeral 51 denotes a mirror.

The optical drive element 52 includes, for example, a first wedge prism pair consisting of a first wedge prism and a second wedge prism, a first voice coil motor for rotationally driving each of the first wedge prism and the second wedge prism, a second wedge prism pair consisting of a third wedge prism and a fourth wedge prism, and a second voice coil motor for rotationally driving each of the third wedge prism and the fourth wedge prism.

Each wedge prism is arranged within a movable frame, and the movable frame is rotatably supported on a fixed frame. The fixed frame is a ring-shaped member in plan view with a circular window at the center. A plurality of coils is arranged on the surface of the fixed frame along the circumferential direction of the fixed frame, each coil being connected in series to a power supply. Further, hall elements are arranged between the coils along the circumferential direction of the fixed frame. The movable frame is also a ring-shaped member in plan view with a circular window at the center in which a wedge prism is fitted. On the surface of the movable frame, magnets are arranged at positions corresponding to the coils and positions corresponding to the hall elements on the fixed frame respectively.

The wedge prisms of the first wedge prism pair are rotated in opposite directions respectively to deflect the signal light in a specific direction (for example, the pitch direction (vertical direction)), and the wedge prisms of the second wedge prism pair are rotated in opposite directions respectively to deflect the signal light in another specific direction (for example, the yaw direction (horizontal direction)). Thus, the optical drive element 52 is configured to rapidly and precisely deflect each of the transmission signal light and the reception signal light to any position on a plane orthogonal to the central axis OA2 of the wedge prisms.

The optical wireless communication apparatus 10 also provides the same effects as those of the optical wireless communication apparatus 1 of Embodiment 1 described above.

### Other Embodiments

The embodiments of the present invention may include two or more optical systems. For example, the optical wireless communication apparatus of the present invention may further include a third optical system and a fourth optical system in addition to the aforementioned optical wireless communication apparatuses 1 and 10. For example, when four optical systems up to the fourth optical system are included, as illustrated in FIG. 4, the mirror surface of the fast steering mirror 5 is divided into a number corresponding to each optical element. In the configuration illustrated in FIG. 4, four symmetrical regions corresponding to the respective first to fourth optical systems are defined on the mirror surface of the fast steering mirror 5. According to such an embodiment, for example, the upper two regions in FIG. 4 can be used as the regions for the transmission signal light and the reception signal light of wavelength A, and the lower two regions in FIG. 4 can be used as the regions for the transmission signal light and the reception signal light of wavelength B, thereby enabling the construction of an optical wireless communication apparatus that supports optical wireless communication in two or more different wavelength bands (for example, L-band and C-band) using one optical wireless communication apparatus. In the present embodiment, it is preferable that the antenna also corresponds to the optical systems, and it is preferable to adopt a four-aperture type antenna.

Here, the term “multi-aperture” means that there is a plurality of positions for the optical axes of the signal light in the antenna. Therefore, in the present invention, as a multi-aperture configuration, the principal mirror and the sub mirror of the antenna may be provided in a number corresponding to the number of optical axes, or each of the principal mirror and the sub mirror may individually have a region for receiving the signal light corresponding to each of the plurality of the signal light beams. The latter configuration may be referred to as “multi-axis”.

In addition, the light source of the signal light in the first optical system may be a laser, and the light reception portion of the second optical system may be a light reception element. Thus, the optical wireless communication apparatus according to the embodiment of the present invention may have a configuration in which the signal light is directly output or detected.

Moreover, the antenna 4 may be two antennas including a first antenna for transmitting the transmission signal light, and a antenna for receiving the reception signal light. Further, the antenna is not limited to an off-axis binocular-type antenna, as long as it is capable of independently transmitting the transmission signal light and independently receiving the reception signal light. For example, the antenna may be a Cassegrain-type antenna. Since the Cassegrain-type antenna is also capable of independently performing both transmission and reception in an integrated manner, the Cassegrain-type antenna is advantageous from the viewpoint of simplifying the configuration of the optical wireless communication apparatus compared with the case of adopting two antennas for transmission and reception.

In the embodiments of the present invention, it is also possible to perform communication using signal light of a specific wavelength by using, for example, a band-pass filter.

### SUMMARY

A first aspect of the present invention provides an optical wireless communication apparatus (1) including: a first optical system (2) that includes a light source (cable connector 21) of a signal light and a first antenna (antenna 4) for transmitting the signal light, the first optical system (2) being configured to transmit the signal light from the light source to the first antenna; and a second optical system (3) that includes a receiver for the signal light and a second antenna (antenna 4) for receiving the signal light, the second optical system (3) being configured to transmit the signal light from the second antenna to the receiver, wherein the first optical system and the second optical system include a parallel portion in which an optical path (20) of the signal light from the first antenna in the first optical system and an optical path (30) of the signal light from the second antenna in the second optical system are parallel to each other, and share an optical drive element (fast steering mirror 5) which is arranged on each of the optical paths in the parallel portion and is configured to deflect the signal light to remove disturbances in a plurality of incident signal light beams. According to the first aspect, it is possible to implement an optical wireless communication apparatus capable of reducing energy loss in signal light while maintaining precise and synchronous control over the communication directions of transmitted and received signal light.

A second aspect of the present invention is the optical wireless communication apparatus according to the first aspect, wherein the optical drive element is a two-dimensional drive mirror capable of changing an orientation of a mirror surface on which the signal light of each optical system is incident. The second aspect is more effective from the viewpoint of more promptly and precisely canceling the influence on the communication light caused by external disturbances.

A third aspect of the present invention is the optical wireless communication apparatus according to the first aspect or the second aspect, wherein the first optical system and the second optical system share an antenna that is configured to transmit and receive a signal light in an integrated manner as the first antenna and the second antenna. The third aspect is more effective from the viewpoint of simplifying the configuration of the antenna.

A fourth aspect of the present invention is the optical wireless communication apparatus according to the third aspect, wherein the antenna is an off-axis binocular-type antenna. The fourth aspect is more effective from the viewpoint of reducing the signal light loss due to transmission and reception through the antenna.

A fifth aspect of the present invention is the optical wireless communication apparatus according to any one of the first aspect to the fourth aspect, wherein the first optical system further includes a first position detection mechanism configured to detect a position of a signal light in a transverse plane of an optical path of the signal light to be transmitted, and the second optical system further includes a second position detection mechanism configured to detect a position of a signal light in a transverse plane of an optical path of the signal light received. The fifth aspect is more effective from the viewpoint of tracking a communication partner based on the position detection of the signal light and the viewpoint of suppressing the influence of disturbances.

A sixth aspect of the present invention is the optical wireless communication apparatus according to the fifth aspect, wherein the first optical system further includes a drive mirror (aberration correction mirror 24) which is arranged between the light source and the first position detection mechanism, the drive mirror being configured to change an orientation of a mirror surface on which a signal light from the light source is incident. The sixth aspect is more effective from the viewpoint of canceling the influence on communication caused by the relative movement of the communication partner.

According to the above embodiments, in optical wireless communication, the present invention reduces energy loss of signal light and does not require the correlation (such as separability) between the transmission signal light and the reception signal light, thereby increasing the degree of freedom of the signal light. The present invention, which achieves such effects, is expected to bring about a groundbreaking advancement and development in optical wireless communication technology, and contributes, for example, to the achievement of Sustainable Development Goal (SDG) 9 proposed by the United Nations, namely “build resilient infrastructure, promote sustainable industrialization and foster innovation”.

The present invention is not limited to the embodiments described above, and various modifications can be made within the scope recited in the claims. Embodiments obtained by appropriately combining technical means disclosed in different embodiments are also included within the technical scope of the present invention.

What is claimed is:

1. An optical wireless communication apparatus comprising:
a first optical system that includes a light source of a signal light and a first antenna for transmitting the signal light, the first optical system being configured to transmit the signal light from the light source to the first antenna; and
a second optical system that includes a receiver for the signal light and a second antenna for receiving the signal light, the second optical system being configured to transmit the signal light from the second antenna to the receiver, wherein
the first optical system and the second optical system include a parallel portion in which an optical path of the signal light from the first antenna in the first optical system and an optical path of the signal light from the second antenna in the second optical system are parallel to each other, and share an optical drive element which is arranged on each of the optical paths in the parallel portion and is configured to deflect the signal light to remove disturbances in a plurality of incident signal light beams.

2. The optical wireless communication apparatus according to claim 1, wherein
the optical drive element is a two-dimensional drive mirror capable of changing an orientation of a mirror surface on which a signal light of each optical system is incident.

3. The optical wireless communication apparatus according to claim 1, wherein
the first optical system and the second optical system share an antenna that is configured to transmit and receive a signal light in an integrated manner as the first antenna and the second antenna.

4. The optical wireless communication apparatus according to claim 3, wherein
the antenna is an off-axis multi-aperture type antenna.

5. The optical wireless communication apparatus according to claim 1, wherein
the first optical system includes a beam splitter arranged on an optical path of a signal light to be transmitted and further includes a first position detection mechanism configured to detect a position of the signal light, and
the second optical system includes a beam splitter arranged on an optical path of a signal light received and further includes a second position detection mechanism configured to detect a position of the signal light.

6. The optical wireless communication apparatus according to claim 5, wherein
the first optical system further includes a drive mirror which is arranged between the light source and the first position detection mechanism, the drive mirror being configured to change an orientation of a mirror surface on which a signal light from the light source is incident.
